(19) United States
(12) Patent Application Publication
(10) Pub. No.: US 2015/0067043 A1
(43) Pub. Date: Mar. 5, 2015

(54) ACCELERATING COLLABORATION IN TASK ASSIGNMENT BY USING SOCIALLY ENHANCED MODEL

(71) Applicant: International Business Machines Corporation, Armonk, NY (US)

(72) Inventors: Shivali Agarwal, Uttar Pradesh (IN); Juhnyoung Lee, Yorktown Heights, NY (US); Rong Liu, Sterling, VA (US); Renuka R. Sindhgatta, Bangalore (IN)

(73) Assignee: International Business Machines Corporation, Armonk, NY (US)

(21) Appl. No.: 14/013,595

(22) Filed: Aug. 29, 2013

(51) Int. Cl. H04L 29/08

(52) U.S. Cl. CPC H04L 67/306
USPC 709/204

(57) ABSTRACT

Communication logs may be analyzed to detect interactions between members, and a social network of members built based on the analysis. A plurality of communities of members is determined in the social network, and social positions of at least some of the members in each of the community are detected. The communities and their member social positions are utilized in dynamically forming a team of members to handle a task assignment.

### FIELD

The present application relates generally to computers, and computer applications, and more particularly to global service delivery, incident and process management using social analytics.

### BACKGROUND

A gap in the current practice in process management for global service delivery and application management services requires that process models be defined before runtime. This process prescription requirement makes it difficult to support dynamic interactions to optimize operations of knowledge-intensive processes and complex decision making.

### BRIEF SUMMARY

A method of accelerating executing tasks for global service delivery, in one aspect, may comprise building a member social network from one or more collaboration logs describing social interactions between a plurality of workers processing tasks, the member social network comprising nodes and edges, wherein a node represents a member and an edge connecting two nodes represents an interaction between two members represented by the two nodes. The method may also comprise formulating a plurality of communities in the member social network, each of the plurality of communities comprising one or more members of the member social network. The method may further comprise determining one or more topics processed by one or more of the plurality of communities. The method may further comprise detecting one or more social positions for at least one member in each of at least some of the plurality of communities based on the built member social network. The method may also comprise updating at least one social profile associated with the at least one member with the detected one or more social positions, wherein the social profile is used to dynamically configure a team of members for executing a task as the task is received for execution.

A system for accelerating executing tasks for global service delivery, in one aspect, may comprise a social network analysis module operable to execute on a computer processor, and further operable to build a member social network from one or more collaboration logs describing social interactions between a plurality of workers processing tasks, the member social network comprising nodes and edges, wherein a node represents a member and an edge connecting two nodes represents an interaction between two members represented by the two nodes. The social network analysis module may be further operable to formulate a plurality of communities in the member social network, each of the plurality of communities comprising one or more members of the member social network. The social network analysis module may be further operable to determine one or more topics processed by one or more of the plurality of communities. The social network analysis module may be further operable to detect one or more social positions for at least one member in each of at least some of the plurality of communities based on the built member social network. The social network analysis module may be further operable to update at least one social profile associated with the at least one member, with the detected one or more social positions, wherein the social profile is used to dynamically configure a team of members for executing a task as the task is received for execution.

A computer readable storage medium and/or device storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating socially enhanced task assignment method in one embodiment of the present disclosure.

FIG. 2 illustrates a socially enhanced model that describes a member in one embodiment of the present disclosure.

FIG. 3 shows an outline of a task assignment algorithm in one embodiment of the present disclosure.

FIG. 4 illustrates an example social network that is built based on an example incident transfer logs.

FIGS. 5A-5D illustrate “brokerage” social positions of a member.

FIG. 6 illustrates an example IT incident management process.

FIG. 7 illustrates a schematic of an example computer or processing system that may implement a social network enhanced assignment system in one embodiment of the present disclosure.

### DETAILED DESCRIPTION

The present disclosure in one aspect describes social process execution, socially-enhanced resource model and socially-enhanced task assignment, dynamically configuring resource units for task execution, leveraging social positions of resources, and forming social compute units and communities by analyzing social interactions.

A global service delivery model refers to a model used by companies engaged in information technology (IT) consulting and service delivery to execute a technology project using globally distributed resources, and for example, to deliver IT enabled services from various locations. IT service management (ITSM) concerns a customer's perspective of IT's contribution to the customer. ITSM may include incident management which aims to restore a normal service operation as quickly as possible and to minimize the impact on business operations, thus ensuring that the best possible levels of service quality and availability are maintained. An incident refers to event which is not part of the standard operation of a service and which causes, or may cause, an interruption to or a reduction in, the quality of that service. Information technology infrastructure library (ITIL) refers to a set of practices for ITSM that focuses on aligning IT services with the needs of business. ITIL describes procedures, tasks and checklists that are not organization-specific, used by an organization for establishing a minimum level of competency. The stated ITIL objective may be to restore normal operations as quickly as possible with the least possible impact on either the business or the user, at a cost-effective price.

A problem in current practice of Business Process Management (BPM) is that process models need to be well defined before runtime. Such requirement presents difficulties in supporting frequent on-demand interactions that usually cannot be prescribed, e.g., knowledge-intensive business process and complex decision-making. In the present disclosure, social BPM may be provided that may include socially-enhanced model with social position information, social compute unit that dynamically configures a unit based on task needs, and social process support.

Social networking has become a powerful paradigm in enabling people to work together. Participation in a business process, too, is “social” in nature. Particularly, knowledge workers interact with each other frequently, share ideas, and build knowledge iteratively to execute complex activities in knowledge-intensive business processes successfully.

An embodiment of the present disclosure extends a traditional model used in BPM with social network features. This extended model may include a number of useful positions in facilitating collaboration among members. Also, a new assignment method may be provided that utilizes the social networking features during task assignment. As an example, a methodology of the present disclosure may be applied to a real-world business process in ITSM to discover the social networks among knowledge workers and incorporate the social network features in assigning IT incidents (business process execution) to appropriate workers. The methodology of the present disclosure in one embodiment may accelerate work tasks (e.g., reduce task execution time).

For example, in IT Service Management (ITSM), support teams troubleshoot IT issues that are formally referred to as IT incidents. Due to the complexity of IT environments, an incident regarding enterprise business applications (e.g. SAP), often requires on-demand collaboration among other support teams in different domains, for example, middleware or operation system teams. However, traditional workflow technologies often have difficulties in supporting processes with frequent on-demand interactions that usually cannot be prescribed during the process design.

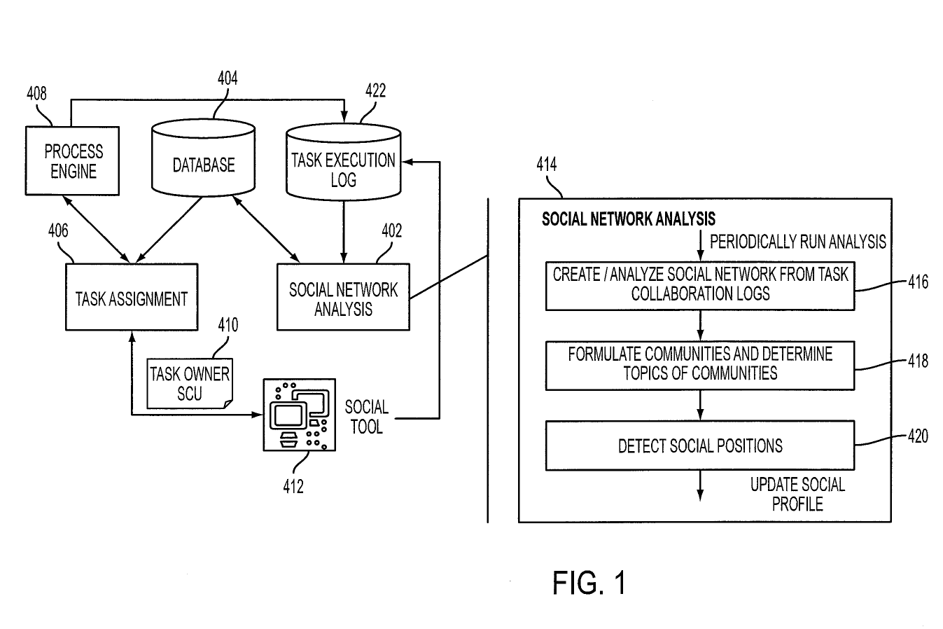

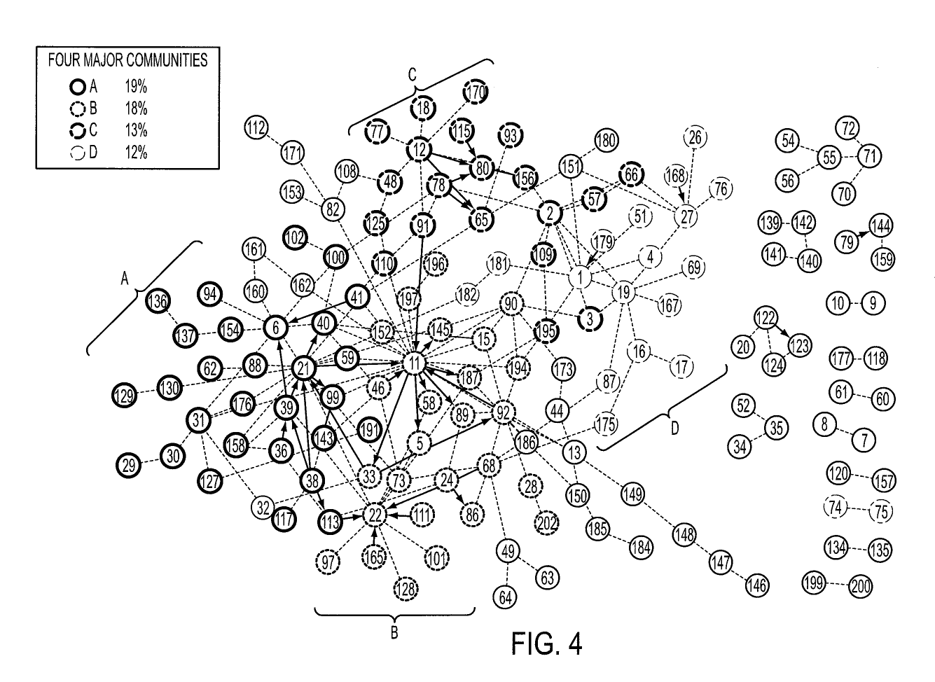

FIG. 1 is a diagram illustrating socially enhanced task assignment method in one embodiment of the present disclosure. A Social Network Analysis module 402 is periodically called to formulate member networks, detect communities, and identify useful social positions, for example, as described in more detail with reference to FIG. 4. The Social Network Analysis module 402 may be implemented as a computer executable module or program, and include analytical programs for social network analysis. For example, as shown at 416, the Social Network Analysis module 402 may create and/or analyze member social network from one or more collaboration logs 422. The member social network may be built, for example, initially from an empty set, or built based on previously created member social network. For instance, the Social Network Analysis module 402 may periodically analyze the collaboration logs 422 and continue to build the member social network based on the periodic analysis.

Collaboration logs 422 may include event logs and/or logs containing details of the activities executed in a process. Interactions (social interactions) between workers, for example, related to process execution, may be captures in such logs. The logs 422 may contain social communications data such as emails, chats, and other data produced by the interactions between workers, e.g., in relation to process or task execution. Those logs 422 may be used to build and analyze the social network of workers or members involved in a process. For example, the workers in the data are extracted, for instance, using natural language processing (NPL), and built as nodes, and interactions among the members (also extracted from the interaction data) are created into edges connecting the nodes that represent the members. For instance, for communication between workers in communication logs, a methodology of the present disclosure in one embodiment may apply NLP to determine who has been involved in the discussion. In the case of transfer logs, each transfer log may have the information about the source and destination workers (e.g., transferor and transferee of a task). In the formed network, each node represents a worker and the link between nodes represents a connection (communication, work transferred, etc.) between the workers. In one embodiment of the present disclosure, the weight of each link shows how strong the connection is (e.g., how many transferred items, how frequently the interaction between nodes occurred, etc.)

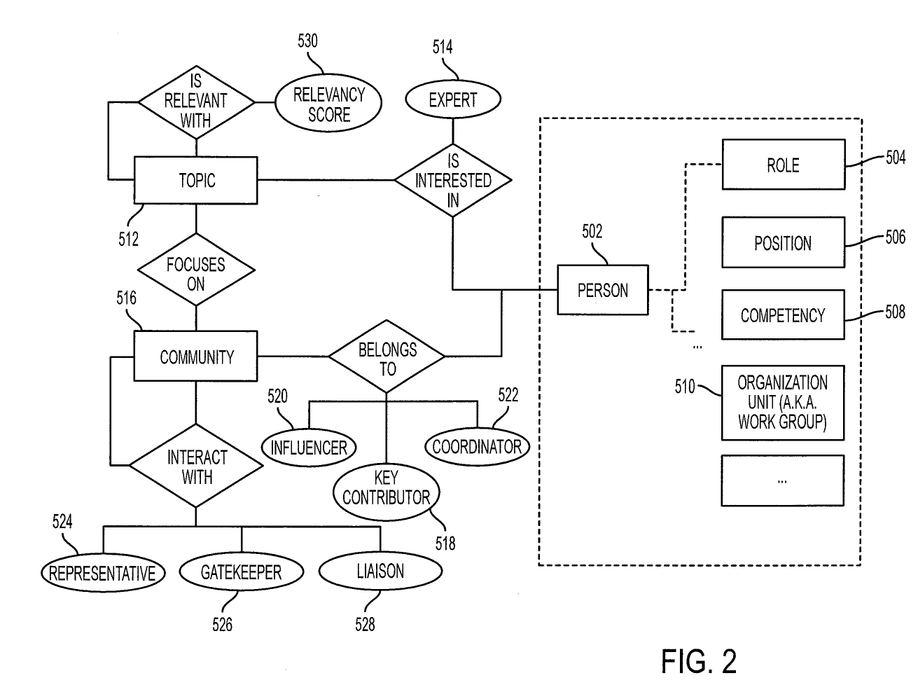

At 418, the Social Network Analysis module 402 may formulate communities and determine topics of communities. At 420, the Social Network Analysis module 402 may detect member social positions. For example, one or more social positions may be detected based on the nodes and edges of the member social network that represent members and communications between members respectively. The identified social positions may be used to assist effective collaboration. The results are saved back into a Database 404 stored in a storage device that has been created based on a socially enhanced model of the present disclosure, for example, as described in more detail with reference to FIG. 2.

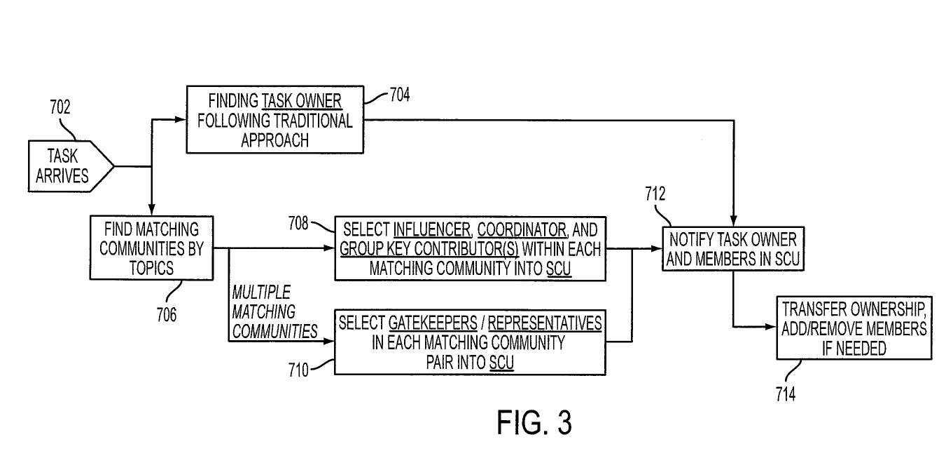

A Task Assignment module 406 receives incoming tasks from a process engine 408 and recommends a task owner and a social computing unit (SCU) 410 for each task, for example, as described with reference to FIG. 3. An SCU refers to a unit of workers formed on-demand to collaborate on a task. The Task Assignment module 406 may be implemented as a computer executable module or component running on a computer processor. A process engine 408 may determine the start of a business process, the start and termination of each activity as prescribed in a business process model, and the termination of the entire process.

A social tool 412 (for example, a social media platform) facilitates collaboration between the task owner and members in SCU. When the Task Assignment module 406 has allocated a task owner and an SCU for a task, the social tool 412 can automatically create a work item for the task and notify members selected. The task owner can start discussion or post questions to specific members in SCU using the social tool 412. Also, transferring task ownership, adding or removing members from SCUs can be done with the social tool 412. The social tool 412 can write the communication logs between members back to the database to enrich task execution log text for topic mining.

In one aspect, a methodology of the present disclosure injects social computing technologies into business process management (BPM) framework, for example, for a higher level of flexibility and efficiency. An SCU is dynamically and virtually formed as a loosely-coupled team of skilled members to execute a specific task for a limited time. As an example, in ITSM an SCU is created based on IT component dependencies involved in an incident. For instance, depending on an application, an SCU can be formed with members from middleware and operation system teams. An embodiment of a methodology of the present disclosure may provide social networks formed during process execution (e.g., knowledge workers form various social communities while participating in business processes), identify different social positions in the networks, and utilize these social positions to dynamically form SCUs for executing tasks in knowledge-intensive processes. A member in the present disclosure describes an entity that is assigned to a process activity during runtime to perform work in order to complete the activity.

FIG. 2 illustrates a socially enhanced model that describes a member in one embodiment of the present disclosure. The model of the present disclosure in one embodiment accommodates social positions of members in the context of BPM. In one embodiment of the present disclosure, each member 502 owns one or more roles 504 and occupies one or more positions 506 in one or more organization units 508. An organization unit 508 may be referred to as a work group that specializes in a particular domain, e.g., a finance work group. Roles 504 and positions 506 specify competency requirements 510. In the present disclosure, in one embodiment, roles 504, positions 506, and organization units 508 specify basic competency requirements 510 for assigning members 502 to a task during process execution. In addition to those basic requirements, for example, when collaboration exists, a dynamic supporting team (i.e. SCU) comprised of various social positions to smooth the collaboration may be provided, for example, to improve the execution efficiency. The social characteristics of members can often help identify the most suitable ones for a task. Also, in case that none of the members satisfies the basic requirements, the social networks of members often can suggest alternative members to fulfill the task.

As shown in FIG. 2, in an extended model of the present disclosure, each member 502 in a social network is interested in one or more topics 512. A topic 512 can be represented as a bag of keywords. Depending on the knowledge of a member, the member can be recognized as an expert 514 on a topic. Also, topics may be related to each other. The relevancy 530 among topics can be measured by their overlapping keywords. Moreover, a member 502 belongs to one or more communities 516 and has a degree of social power. The social power is reflected in the member's social positions, the roles played in connecting groups.

In one embodiment, the following social positions within a community are identified: key contributor 518, influencer 520 or coordinator 522. A key contributor 518 is an active member within a community, e.g., constantly executing a fair number of tasks. If a community 516 includes a number of organization units (or work groups), a methodology of the present disclosure in one embodiment may also identify group key contributors. An influencer 520 is a social position who has high influence power over a community 516. This influence power is often interpreted as leadership. In one embodiment, a proper measure of influence is considered as eigenvector centrality or the generalized Bonacich's centrality. A coordinator 522 within a community is a position that connects others and thus can be measured by betweenness centrality. A measure for a coordinator 522 may be determined based on betweenness centrality. A community 516 is formed by a group of members (e.g., people) who have common interest on certain topics. Thus, a community 516 often focuses on a collection of related topics.

People within a community often interact with other communities. A member 502 within a community 516 may act as a representative 524, which directly connects to other communities and is on most outgoing paths of this community to others. A gatekeeper 526 of a community 516 is a member to which other communities often directly connect for communication going to this community 516. Gatekeepers and representatives play a communication role across communities. They form sub-network by only links cutting across each pair of communities. A measure of gatekeeper is considered as an indegree centrality. A measure of representative is considered as an outdegree centrality. A liaison 528 is a member in a community 516 who acts as a bridge for communication between two other communities.

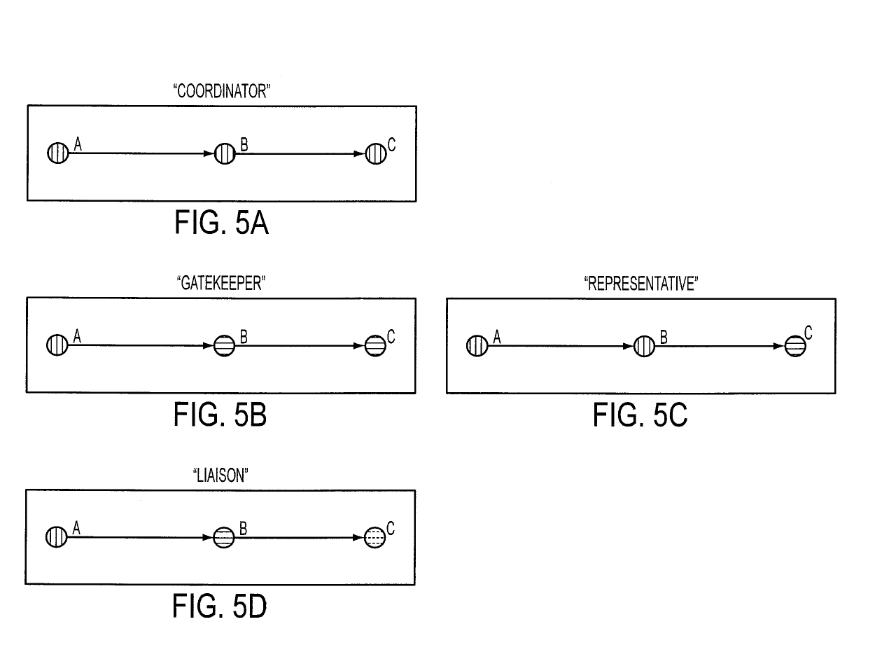

FIGS. 5A-5D illustrate “brokerage” social positions of a member, e.g., B. FIG. 5A illustrates a coordinator (B) that connects to others (A, B) in the same community. FIG. 5B illustrates a gatekeeper (B) of a community that includes member (B, C). In FIG. 5B, member (A) from a different community connects to the gatekeeper (B). In FIG. 5C, a representative (B) is in a community with a member (A), wherein the member (A) connects to the representative (B) to connect to another member (C) in another community. In FIG. 5D, a liason (B) who is a member of a community connects two members (A, C) from two other different communities.

In one embodiment of a methodology of the present disclosure, during work collaboration, when members collaborate on tasks, their social positions are considered in assignment of members to tasks. For example, if a task requires members from two different communities, it will be useful to involve gatekeepers and representatives of the communities to facilitate collaboration. Similarly, a coordinator of a community can help collaboration on tasks among members within the community during process runtime. Hence, a methodology of the present disclosure creates a model that includes social characteristics and utilizes this model in process execution.

Most enterprises leverage IT systems for efficiently conducting their business. IT systems are often managed by service providers who have suitably skilled members responsible for supporting and maintaining the systems to keep them functioning healthily. Typically, members are organized into different work groups by their specialty, e.g., database group, operation system group, etc. Business users of the IT systems submit incidents when they face issues with the systems. Entities from the service provider work on incidents and resolve the issues within timelines as defined in a service level agreement. A methodology of the present disclosure is described below as applied to an IT system's incident management system to illustrate an example. It should be understood, however, that the methodology of the present disclosure may apply to other business processes.

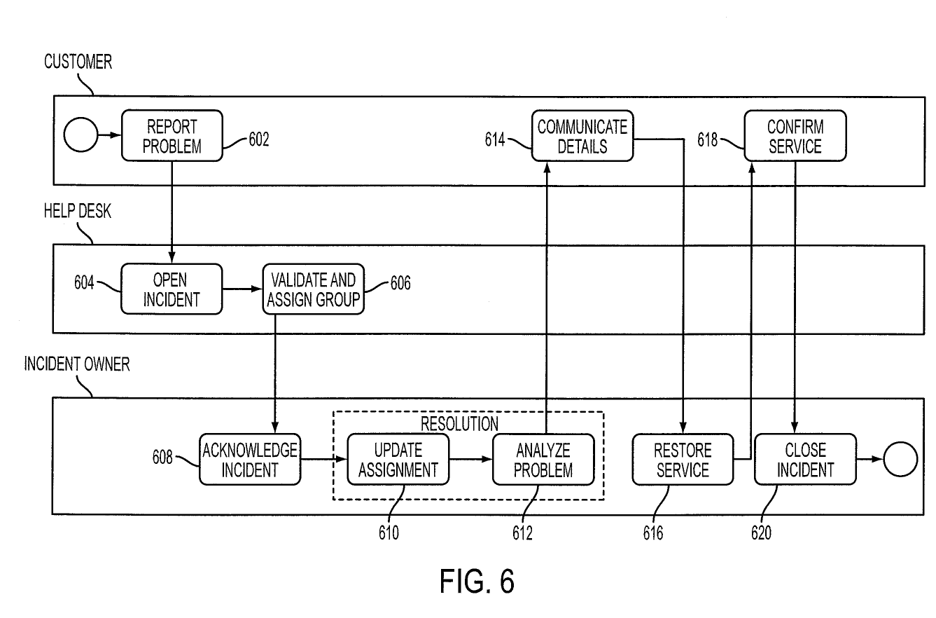

FIG. 6 illustrates an IT incident management process. A problem or issue 602 faced by a business user is reported to a help desk. The help desk personnel ‘opens an incident ticket’ 604 in a ticketing tool and records the description of the issue faced by the user typically in a free-text form. Then the incident is assigned to a specific work group 606 based on the problem described by the user. The incident, once assigned to a work group, is picked up by an available worker within the work group. The worker may acknowledge the receipt of the incident 608 and start the resolution stage. The resolution stage of this process may contain the following activities: the assignment update 610 and the problem analysis 612. The worker updates the assignment information 610 indicating the ownership of the incident. The worker further analyzes the problem in the ticket 612, communicates to the business user for more input on the problem 614, and resolves the problem. Once an incident is resolved, the worker restores the functionality of the system 616 as required by the business user. The business user validates and confirms the service 618 provided by the worker. Once confirmed by the business user, the incident is closed 620.

Note that the resolution stage in this process is iterative for a number of reasons: (1) the incident may be misrouted if its recorded information is insufficient, (2) the assigned worker may become unavailable, and/or (3) for the complexity nature of issues involved in the incident, multiple workers with different specialties may be required in the diagnosis and resolution. Incidents, particularly, ones regarding application outages, are often complicated as their root causes can be aggregated from different layers in IT environments, including the application, middleware, hardware, network infrastructure, etc. In the current practice, an incident is assigned to one worker at a time. When necessary, the assigned worker can request an incident transfer by returning the incident to an incident dispatcher. Then, the dispatcher looks for another suitable worker. Because of the hand-over time involved, transferred tickets are more likely to miss the predefined resolution deadline. An incident transfer reflects the need for collaboration. Even in the case of a misrouted incident, each assigned worker analyzes the incident and adds more diagnosis knowledge to the incident until it reaches the right worker for resolution.

To create a social network of members (e.g., workers), communications between workers during process execution that are logged may be considered. For example, workers for activities in the resolution stage may be considered as interesting social interactions can be observed from logs of incident transfers. Such logs may include task execution logs that describe incidents transferred to different workers during incident resolution. The communications and/or patterns of the communications are utilized to form SCU for assignment.

FIG. 4 illustrates an example social network that is built based on an example incident transfer logs. In this network, each node is a worker (member) and a direct link indicates incident transferred from the source node to the target one with the number of transferred incidents as the weight. This setup gives a network of 154 nodes and 220 edges, as shown in FIG. 4. Note that such a social network can also be derived from communication logs between workers over a task if such communication logs exist.

To detect communities in the built social network, an algorithm for detecting communities in systems may be applied. Other clustering algorithms such as hierarchical clustering algorithms may be utilized for detecting communities in the social network. An example algorithm is Girvan and Newman's algorithm. In Girvan and Newman's community detection algorithm, a community (i.e., cluster) includes a subset of nodes within which the node-node connections are dense, and the edges to nodes in other communities are less dense. Modularity measures the strength of division of a network into modules. Modularity is the fraction of the edges that fall within the given groups minus the expected such fraction if edges were distributed at random. The algorithm finds the edges that are most “between” communities and removes them to detect community iteratively:
1. The betweenness of all existing edges (the shortest paths between a pair of nodes that run through it) in the network is calculated first;
2. The edge with the highest betweenness is removed;
3. The betweenness of all edges affected by the removal is recalculated;
4. Steps 2 and 3 are repeated until no edges remain.

In the above specified example incident transfer data, this algorithm returned 21 communities with modularity 0.62, indicating significant community structure existing in this network. This network partitioned by these communities (differentiated by shading) is shown in FIG. 4. In this network, there are four major interconnected communities with large populations (referred to as Communities A, B, C & D), while other communities are relatively small and many are isolated with each other. For example, the largest community, Community A, consists of 29 members. Some communities are aligned with members' work group structures, while others spread across multiple work groups, indicating strong collaboration between these groups. For example, in Community B, among the total 28 resources, there are 10 members from work group X, 7 members from work group Y, 3 from work group Z, and the other from a few groups related to IT infrastructure. However, the small community (comprising members 112, 171, 153, 108 and 82) on the top of FIG. 4 has 5 members solely from a work group in charge of particular applications. Although a direct result of this network partition algorithm may assign a member to only one community, a methodology of the present disclosure allows a member to participate in more than one community as indicated in FIG. 2's model. These detected communities can be adjusted based on the interest of members.

To discover main topics, natural language processing and machine learning may be applied. For example, in the above specified example data, a topic modeling technique (e.g., LDA (Latent Dirichlet allocation)) may be applied to discover main topics from the incidents handled by the predefined number of top largest communities, for instance, top largest communities that would have processed a sufficient number of incidents for topic mining.

Inn LDA topic discovery approach, each document is viewed as a mixture of various topics (assume a Dirichlet prior for topic distribution). A topic is a mixture of words by word distribution (Dirichlet prior). With observations, a methodology of the present disclosure in one embodiment can learn topics and keywords in each topic.

Each topic is represented as a bag of keywords. The topics of each community can be considered as an affinity bond among the members. A community can focus on a number of related topics. Communities can also have overlapping topics, but each community should have at least one topic that distinguishes itself from others. If two communities have all similar topics, there is a good reason to combine them.

Table 1 shows an example of discovered communities and topics for each community from the example incident transfer log data. Tickets processed by Community A are determined to be associated with four major topics, including Purchasing, Payment, Invoice and Web Method Integration, with sample keywords shown in Table 1. For example,

TABLE 1

| Com- | | | |
|---|---|---|---|
| munity | Size | Group Mix | Topics |
| A | 29 | Procure to Pay, | Purchasing: purchasing order, shopping |
| | | Web Methods | cart, goods movement, buyer, process |
| | | Application, | Payment: payment, request, approval, |
| | | Custom | transaction, vendor |
| | | Application | Invoice: invoice, item, line, code |
| | | | Web Methods Integration: Hub, Request |
| B | 28 | Security, | User Password: User ID, user locked, |
| | | Travel and | password reset |
| | | Expense, | Access: authentication, connection, |
| | | HR Payroll | access, role, applicable, portal, self |
| | | | service, registration |
| | | | HR Expense & Payroll: employee, time, |
| | | | trip, deposit, business |
| C | 20 | Planned | PTC: ledger, session, task abended |
| | | Transport | (abnormal end of task), printing failure |
| | | Charges (PTC), | Reports: source, error, report, filename |
| | | Business | |
| | | Reports | |
| D | 19 | Business | Reporting: report, file, excel, |
| | | Reports, | attachment, record, pdf, accessing, |
| | | Security | absence, transport |

The methodology of the present disclosure further identifies one or more social positions associated with one or more members in the identified communities. Table 2 lists identified social positions, e.g., influencers, coordinators, and group key contributors.

TABLE 2

| | Coordinator | | Influencer | | Key Contributor | | |
|---|---|---|---|---|---|---|---|
| Community | Member | Betweenness | Member | Eigenvector | Member | Workgroup | Degree |
| A | 21 | 87 | 36 | 0.46 | 21 | Procure to | 37 |
| | | | | | | pay | |
| | 40 | 24 | 39 | 0.39 | 39 | Custom | 28 |
| | | | | | | application | |
| | 6 | 27 | 38 | 0.37 | 40 | Procure to | 21 |
| | | | | | | pay | |
| | 31 | 18 | 21 | 0.35 | 36 | Web | 12 |
| | | | | | | method | |
| | | | | | | application | |
| B | 11 | 265 | 90 | 0.47 | 11 | security | 26 |
| | 92 | 206 | 11 | 0.39 | 22 | HR travel | 15 |
| | | | | | | and expense | |
| | 22 | 152 | 15 | 0.34 | 92 | HR payroll | 9 |
| | 68 | 151 | 92 | 0.30 | 33 | security | 7 |
| C | 12 | 90 | | 0.39 | 80 | SAP | 18 |
| | | | | | | Finance | |
| | | | | | | PTC | |
| | 2 | 75 | | 0.47 | 12 | SAP | 15 |
| | | | | | | Finance | |
| | | | | | | PTC | |
| | | | | 0.46 | 78 | SAP | 13 |
| | | | | | | Finance | |
| | | | | | | PTC | |
| | | | | | 2 | Business | 8 |
| | | | | | | reports | |
| D | 1 | 24 | | 1.54 | 1 | Business | 7 |
| | | | | | | reports | |
| | 19 | 23 | | 1.35 | 19 | security | 6 |

For each community, coordinators may be identified as those who have high betweenness centrality score. Betweenness centrality of a node measures the number of shortest paths from all nodes to all the others that pass through that node. For example, referring to FIG. 4, in Community A, member node 21 has the highest betweenness centrality score, 87. This can be confirmed by the fact that this node is located in the center of many paths, as shown in FIG. 4. In ITSM domain, coordinators are often IT architects, team leads or managers responsible for coordinating groups working on similar topics.

Influencers may be identified through eigenvector centrality. This metric assigns relative scores to all nodes based on the concept that connections to high-scoring nodes weigh more than those to low-scoring nodes. A node with a high betweenness centrality score may not always have a high eigenvector centrality score. In Community A, member node 36 has the highest score, as it is able to reach a number of members that are also influential.

Group key contributors may be identified by the degree centrality, i.e., the number of edges of a node. Note that a member may have multiple social positions. For example, member node 21 acts as a key contributor, an influencer, and a coordinator. This member is likely a technical leader or a proficient subject matter expert (SME) who has technical authority in this community.

Communities may interact with each other through representatives and gatekeepers. Representatives typically correspond to leads or managers. Gatekeepers can be considered as dispatchers or points of contact within a community. To identify gatekeepers and representatives, a sub-network that is formed by only the links cutting across each pair of communities may be analyzed. Then, both the indegree and outdegree centrality of each node in this sub-network may be measured. A node with a high indegree centrality score is recognized as a gatekeeper, and a node with a high outdegree score is considered as a representative. For example, a community can have more than one gatekeeper or representative. This may be particularly true for a large community with more than one topic. Based on the centrality score, a methodology of the present disclosure in one embodiment may specify the top n members (a predefined threshold) as gatekeepers and representatives. Briefly, indegree refers to edges coming into a node; outdegree refers to edges going out of a node.

Briefly, degree centrality is the number of direct relationships that a member has. A worker with a high degree centrality: is generally an active player in the network; is often a connector or hub in the network; is not necessarily the most connected worker in the network (a worker may have a large number of relationships, the majority of which point to low-level engineers); may be in an advantaged position in the network; may have alternative avenues to satisfy organizational needs, and consequently may be less dependent on other individuals; can often be identified as third parties or deal makers.

Betweenness centrality identifies a worker's position within a network in terms of its ability to make connections to other pairs or groups in a network. A worker with a high betweenness centrality generally: holds a favored or powerful position in the network; represents a single point of failure; has a greater amount of influence over what happens in a network.

Eigenvalue measures how close a worker is to other highly close workers within a network. In other words, Eigenvalue identifies the most central workers in terms of the global or overall makeup of the network. A high Eigenvalue generally: indicates an actor that is more central to the main pattern of distances among all workers; is a reasonable measure of one aspect of centrality in terms of positional advantage. Workers that many other workers point to are called Authorities. If a worker has a high number of relationships pointing to it, it has a high authority value, and generally: is a knowledge or organizational authority within a domain; acts as definitive source of information.

Table 3 shows a few top-ranked gatekeepers and representatives in each pair of these four major communities shown in the example social network of FIG. 4.

TABLE 3

| Community | | Representative | | Gatekeeper | |
|---|---|---|---|---|---|
| Pair | Community | Member | Outdegree | Member | Indegree |
| (A, B) | A | 21 | 3 | 21 | 5 |
| | A | 113 | 3 | | |
| | B | 33 | 2 | 11 | 7 |
| | B | | | 22 | 3 |
| (A, C) | A | 21 | 1 | 41 | 1 |
| | A | 100 | 1 | | |
| | C | 65 | 1 | 110 | 1 |
| | C | | | 78 | 1 |
| (A, D) | A | | 1 | 21 | 1 |
| | D | 182 | | | |
| (B, C) | B | 90 | 1 | 11 | 3 |
| | B | 187 | 1 | | |
| | C | 91 | 2 | 3 | 1 |
| | C | | | 195 | 1 |
| (B, D) | B | 68 | 2 | | |
| | B | 194 | 1 | | |
| | D | | | 1 | 1 |
| | D | | | 87 | 1 |
| | D | | | 175 | 1 |
| (C, D) | C | 2 | 2 | 2 | 1 |
| | D | 1 | 1 | 19 | 2 |

In this example, member node 21 in Community A and member node 11 in Community B act as representative and gatekeeper, respectively, in addition to their many other social positions (see Table 2). From the scores, it can also be seen that in general communication between communities is not very frequent, and Communities A and B have more interactions than other pairs. This also confirms that this network has a strong community structure. In this particular example network, no liaison positions were found, because each community pair interacts with each other directly. The identified social positions may be used in task assignment to facilitate effective collaboration among resources.

The following description illustrates an algorithm for task assignment that takes into account social positions within communities in conjunction with their roles, work groups, and organizational positions. The algorithm is illustrated by using the real world incident management example where the model (e.g., shown in FIG. 2) is enhanced using the social network features described above. This algorithm is not specific to ITSM and may be applicable to task assignment in other processes, e.g., knowledge intensive processes, as well. It can be effectively applied without any modification as long as the social network properties on past collaboration are available.

Traditionally, incident assignment is to find appropriate workers based on work groups, skills and availability. For example, a predictive learning model has been created to assign an incident to a work group and then any worker within the work group can pull the incident based on availability. This predictive model first extracts features from the incident description using text analytics and then classifies incidents according to work groups using classification approaches like support vector machines (SVMs). However, this traditional approach faces challenges as complex enterprise IT environments request more collaboration across technology domains. This point is evidenced by frequent incident transfers (e.g., in incident management), calling for collaboration across work groups. About 20% of incidents request for a transfer after initial assignment. It is more likely that a transfer incident cannot meet its predefined timeline following the sequential process, thus resulting in a penalty. In many cases, it is also observed that although there is no formal incident transfer, frequent communication over incidents happens between workers within the same work group or across work groups.

An algorithm of the present disclosure augments the traditional incident assignment approach with a social compute unit (SCU) assisting a task owner. The algorithm utilizes worker social networks to arrive at such a collaborative unit when a task (e.g., an incident in an incident management system) needs to be assigned. The underlying assignment philosophy is that when an incident arrives, there will be a primary owner for the incident and also a group of workers who will be informed about this incident in anticipation of collaboration. Thus, for example, for each high priority incident, a primary owner may be assigned and a group of resources are formed as an SCU in anticipation of collaboration. The SCU uses their knowledge and social power to bring suitable members together assisting the task owner in completing the task efficiently. With SCUs, incident transfers for the purpose of collaboration can be eliminated at best or can be minimized. Also, in case an incident is misrouted, the transfer can happen between the task owner and a member in the SCU, then reducing the hand-over time and cost. This algorithm is especially useful in a situation where a member has not developed his own collaborative network and is dependent on dispatchers or team leads for getting relevant information from other groups. A formally assigned SCU to such a member can be helpful in reducing the time taken to establish contacts and exchanging information.

FIG. 3 shows an outline of a task assignment algorithm in one embodiment of the present disclosure. Assuming that member social networks have been analyzed, communities are well formulated, and different social positions are identified using, e.g., the approach described above, this algorithm may be triggered when a new task or process 702 (e.g., incident in an incident management system) arrives. In one embodiment of the present disclosure, at 704, traditional approaches, for example, the predictive learning model may be used to recommend a workgroup as usual and optimization models are used to determine the task owner based on load, availability and skill expertise.

Then, the following steps are taken to recommend members forming a social compute unit (SCU) for the task owner. At 706, for an incoming task (e.g., incident), the algorithm in one embodiment associates one or more communities that are most relevant to the task based on the keywords present in task description. The task (e.g., incident) can be matched to one or multiple communities. There are two cases: In one case (referred to as case A), the task (e.g., incident) is matched with one community; In another case (referred to as case B), the task (e.g., incident) is matched with multiple communities. The following describes steps taken in the algorithm for each of the two cases.

Case A: The incident is matched with one community.

At 708, the algorithm in one embodiment of the present disclosure chooses an influencer node and a coordinator node from the matching community and adds them to the SCU. In case there are multiple influencer/coordinator nodes, the algorithm may choose the one with best availability and least load. The influencer and coordinator can leverage their broad knowledge and social power to advice possible resolution strategies and recommend suitable members to collaborate based on their understanding of the task (e.g., incident). If there is a member that qualifies as both a coordinator and an influencer, then the algorithm in one embodiment may give preference that person in order to optimize member utilization.

In one aspect, if the matching community has multiple work groups, the algorithm may choose a key contributor from each group based on load and availability. If an influencer/coordinator is also a key contributor for a workgroup, then there is no need to pick a different key contributor from that work group. The algorithm may add the key contributor that is also an influencer/coordinator to the SCU.

In case a key contributor is unavailable due to workload, the algorithm may suggest the next best option from the list of resources in the workgroup based on degree centrality. These key contributors can provide specific domain knowledge in assisting task execution if needed.

Case B: The incident is matched with multiple communities.

In this case, the algorithm includes completing all steps in Case A for each community, for example, at 708. At 710, the algorithm further includes choosing a representative and a gatekeeper from each pair of matching communities in case they are not already chosen in the capacity of their other social positions. The algorithm adds them the SCU. In this case, it is very likely that the task requires collaboration across communities. Representatives and gatekeepers can facilitate and smoothen the process of collaboration.

At 712, the algorithm further includes notifying the task owner and SCU of the task (e.g., incident). So far, an initial SCU is reached. The task owner can consult with members in the SCU to handle the task (e.g., diagnose incident).

At 714, if needed, members from the SCU can be added or removed, and task ownership can be transferred to a member in the SCU. For example, coordinators can choose to disregard the choices suggested for key contributors and choose a member based on their discretion. As the task goes on, coordinators and influencers can recommend new members or remove members from the SCU. Also, members in these positions may delegate the task to another suitable member.

As described above, an SCU is computed based on social positions and resource availability and workload. Each task has a task owner and an SCU. An SCU is informed about the task in anticipation of collaboration.

TABLE 4

Incident ID: INC1
Open Time: Aug. 3, 2010 8:31:47 AM Close Time:
Jul. 16, 2010 6:55:20 AM
Description: The USER xxx has a successful login
into the hub after registration, but he is unable
to access SAP. Every time when he clicks on Sap
work place, the screen goes blank!
Incident ID: INC2
Open time: Aug. 23, 2010 2:02:16 PM Close Time:
Jul. 28, 2010 6:34:41 PM
Had system reimaged a few months ago, has not been
able to perform goods movement, had previous incident
opened (INCx) to report authorization issue, but is still
unable to complete work, referring back to appropriate
parties at higher severity. Please help to check.

The following description illustrates a few incidents as example tasks to explain the above-described algorithm. Table 4 shows two example incidents. For incident INC1, clearly, based on the incident description, the best match community is found to be Community B that focuses on topics related to user access. This example corresponds to Case A, where a single matching community is found. Based on the social position as shown in Table 2, some of the possible SCUs that the algorithm will provide are listed below.
i. Member node 90 (influencer), 92 (coordinator and key contributor of work group “HR Payroll”), 11 (key contributor of work group “Security”), 22 (key contributor of work group “Travel and Expense”).
ii. Member node 11 (influencer, coordinator and key contributor of “Security” work group), 92 (key contributor of work group “HR Payroll”), 22 (key contributor of work group “Travel and Expense”).
iii. Member node 90 (influencer), 92(coordinator and key contributor of work group “HR Payroll”), 33 (key contributor of “Security” workgroup), 22 (key contributor of work group “Travel and Expense”).

The options (i) and (ii) are self explanatory from the algorithm. The option (iii) has been given here to highlight the fact that it is not necessary to choose the topmost coordinator or influencer because the SCU may be chosen based on the availability of these resources and their workload. The SCU in option (iii) illustrates the case when member node 11 is not available. The actual task execution logs of this incident show that this incident has been transferred three times from the initial assigned task owner member node 5: 5→33→92→11. This transfer sequence conforms to the SCU suggested by the algorithm of the present disclosure based on social positions. With the support team in place (SCU), this incident would be resolved sooner that having to sequentially transfer the task to those members.

For the second example in Table 4, Incident INC2, the analysis of the text associated with the incident recommends both Communities B and A as the best match. The text has references to keywords “goods movement” and “authorization” which match with the topics that the methodology of the present disclosure in one embodiment has associated with these two communities. Following the steps of the algorithm, some of the possible SCUs suggested are:
i) Community A: 21 (coordinator, key contributor, gatekeeper, and representative), 36 (influencer, key contributor), 39 (key contributor).
Community B: 92 (coordinator, influencer, key contributor), 11 (gatekeeper, key contributor), 33 (representative), 22 (key contributor).
ii) Community A: 21 (coordinator, gatekeeper, and representative), 36 (influencer, key contributor), 40 (key contributor), 39 (key contributor).
Community B: 90 (influencer), 11 (coordinator, key contributor, and gatekeeper), 22 (key contributor), 33 (representative), 92 (key contributor).

From the actual incident logs, it is found that the incident was transferred back and forth between Communities A and B starting with the initial assigned member node 21 in Community A: 21 (A)→40 (A)→46 (B)→11 (B)→187 (B)→40 (A)→15 (B)→11 (B)→145 (B)→21 (A). At the end, the incident returns to member node 21 for closure. This case indicates that the transfer is caused by necessary collaboration instead of misrouting. It can be seen from the logs that the key social positions do get involved and the transfers to normal contributors typically have a pattern of coming from these powerful positions.

A model for process execution in the present disclosure is augmented with social characteristics of workers/members. This model incorporates social concepts such as communities, topics, and various social positions along with traditional concepts such as roles and work groups, and is able to support knowledge-intensive processes. A Social Compute Unit, a dynamic collaborative team form on demand, is also introduced in the present disclosure to execute a task in an efficient manner. This approach includes analytical steps. It first formulates social networks based on process execution logs or the like data, and detects communities in such networks. Then, it associates each community with appropriate topics, and identifies a number of useful social positions within a community or across communities. It applies an algorithm to recommend an SCU to an incoming task based on topic matching and identified social positions.

In one aspect, the methodology of the present disclosure moves a step further from known methodologies to identify different member social positions and use them to create SCUs for collaborative task execution. An approach to forming an SCU in the present disclosure, in one aspect, differs from known methodologies in that SCUs in one embodiment of the present disclosure may be recommended based on social positions but not on dependencies involved in a task.

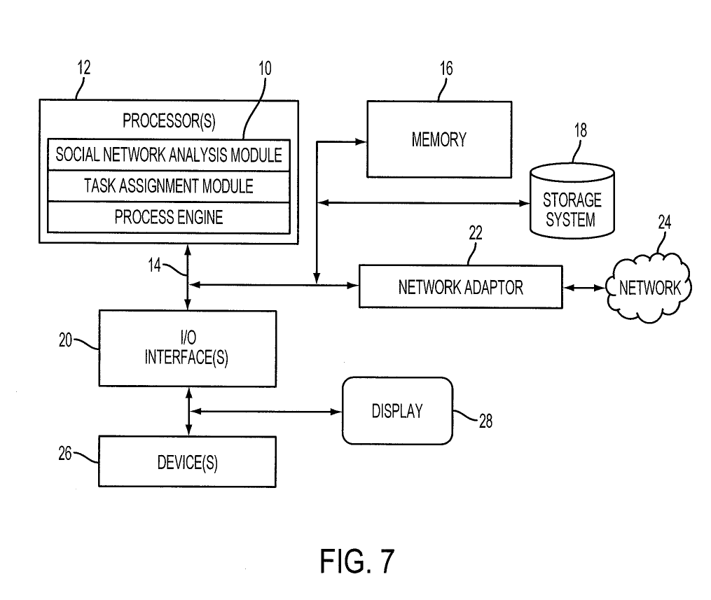

FIG. 7 illustrates a schematic of an example computer or processing system that may implement a social network enhanced assignment system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 7 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of accelerating executing tasks for global service delivery, comprising:
building, by a computer processor, member social network from one or more collaboration logs describing social interactions between a plurality of workers processing tasks, the member social network comprising nodes and edges, wherein a node represents a member and an edge connecting two nodes represents an interaction between two members represented by the two nodes;
formulating, by the computer processor, a plurality of communities in the member social network, each of the plurality of communities comprising one or more members of the member social network;
determining, by the computer processor, one or more topics processed by one or more of the plurality of communities;
detecting one or more social positions for at least one member in each of at least some of the plurality of communities based on the built member social network; and
updating at least one social profile associated with the at least one member with the detected one or more social positions, wherein the social profile is used to dynamically configure a team of members for executing a task as the task is received for execution.

2. The method of claim 1, wherein the building is performed continually based on periodic analysis of the one or more collaboration logs.

3. The method of claim 1, wherein the formulating the plurality of communities is performed by employing a community detection algorithm.

4. The method of claim 1, wherein the determining the one or more topics is performed by employing a topic modeling technique.

5. The method of claim 1, wherein the social profile is associated with one member, and the social profile describes at least a member community the one member belongs to, a community topic that the member community processes, and one or more member social positions of the one member.

6. The method of claim 1, wherein the one or more social positions are detected from at least one of influencer, key contributor, coordinator, representative, gatekeeper, and liaison.

7. The method of claim 6, wherein the coordinator detected as a node with highest betweennes centrality in a community of the member social network.

8. The method of claim 6, wherein the influencer is detected as a node with highest eigenvector centrality score in a community of the member social network.

9. The method of claim 6, wherein the key contributor is detected as one with highest degree centrality in a community of the member social network.

10. The method of claim 6, wherein the representative is detected as one with highest outdegree score between sub-networks representing the plurality of communities.

11. The method of claim 6, wherein the gatekeeper is detected as one with highest indegree score between sub-networks representing the plurality of communities.

12. The method of claim 1, further comprising:
receiving the task for execution;
finding one or more matching communities from the plurality of communities by matching the topics associated with the plurality of communities and one or more keywords present in task description of the task for execution;
selecting an influencer, coordinator, and key contributor within each of the matching communities based on social profiles associated with members in the matching communities, the social profiles updated based on the built member social network; and
dynamically configuring the team of members for executing the task.

13. The method of claim 12, further comprising selecting a gatekeeper and representative within each of the matching communities, in response to finding more than one matching community.

14. The method of claim 12, further comprising finding a task owner associated with the task for execution and notifying the task owner of the dynamically configured team of members.

15-19. (canceled)

20. The method of claim 1, further comprising:
receiving the task for execution;
finding one or more matching communities from the plurality of communities by matching the topics associated with the plurality of communities and one or more keywords present in task description of the task for execution;
selecting an influencer, coordinator, and key contributor within each of the matching communities based on social profiles associated with members in the matching communities, the social profiles updated based on the built member social network; and
dynamically configuring the team of members for executing the task.
